(19) United States
(12) Patent Application Publication
(10) Pub. No.: US 2020/0151885 A1
(43) Pub. Date: May 14, 2020

(54) METHOD AND APPARATUS FOR DETERMINING MOVING TRACK

(71) Applicant: HUAWEI TECHNOLOGIES CO., LTD., Shenzhen (CN)

(72) Inventors: Li YANG, Shanghai (CN); Weiwei SUN, Shanghai (CN); Hao WU, Shanghai (CN)

(21) Appl. No.: 16/746,666

(22) Filed: Jan. 17, 2020

Related U.S. Application Data
(63) Continuation of application No. PCT/CN2018/094740, filed on Jul. 6, 2018.

(30) Foreign Application Priority Data
Jul. 18, 2017 (CN) 201710586941.1

(51) Int. Cl. G06T 7/215; G06T 7/207

(52) U.S. Cl. CPC G06T 7/215; G01C 21/30; G06T 2207/10016; G06T 7/207

(57) ABSTRACT

A method includes obtaining locations of n original track points P₁ to Pₙ during a moving process of a mobile terminal. A time point at which the mobile terminal passes an i^{th} original track point Pᵢ in the n original track points P₁ to Pₙ is earlier than a time point at which the mobile terminal passes an (i+1)^{th} original track point Pᵢ₊₁. The method also includes performing a filtering process on the n original track points P₁ to Pₙ. The filtering process one or more of deletes at least one of then original track points P₁ to Pₙ or updates a location of at least one of the n original track points P₁ to Pₙ. The method further includes determining a moving track of the mobile terminal on at least one road included in a road map based on target track points obtained by performing the filtering process.

### CROSS-REFERENCE TO RELATED APPLICATIONS

This application is a continuation of International Application No. PCT/CN2018/094740, filed on Jul. 6, 2018, which claims priority to Chinese Patent Application No. 201710586941.1, filed on Jul. 18, 2017. The disclosures of the aforementioned applications are hereby incorporated by reference in their entireties.

### TECHNICAL FIELD

This application relates to fields of information technologies, and more specifically, to a method and an apparatus for determining a moving track.

### BACKGROUND

Map matching is an error correction technology for moving track data. The technology is based on a pattern recognition theory, and may be based on an assumption that a vehicle always travels on a road. A basic idea of the technology is to compare and match vehicle location information measured by using a positioning method with electronic map data of a navigation system with reference to a vehicle positioning track and a road network in a digital map, to find a road segment on which a vehicle is located. A combination of a positioning technology and a map matching technology can effectively reduce an error caused by positioning sampling and greatly improve accuracy of vehicle positioning, and has been widely applied to fields such as global positioning system (GPS) navigation and traffic flow analysis.

In the existing map matching technologies, map matching based on a hidden Markov model (HMM) has the best accuracy and robustness. The method is mainly designed for a track with a small error, for example, a GPS track of which the error is at the level of 10 m, and in terms of matching accuracy, an ideal result can be achieved.

At present, it is relatively easy to obtain base station positioning data, user mobile phones are very popular, unlike GPS positioning, there is no need to actively turn on a GPS switch, a volume of obtained data is relatively large, and abundant information is included. Therefore, it is necessary to provide a map matching technology that is based on the base station positioning data. If an existing HMM map matching algorithm is used, for a track with a large error such as base station track data, the error is at the level of 100 m, and in terms of matching accuracy, an ideal result cannot be achieved.

### SUMMARY

This application provides a method and an apparatus for determining a moving track, capable of filtering and correcting a track point that may have a negative effect during a map matching procedure.

According to a first aspect, a method for determining a moving track is provided, including: obtaining locations of n original track points P₁ to Pₙ during a moving process of a mobile terminal, where a time point at which the mobile terminal passes an i^{th} original track point Pᵢ in the n original track points P₁ to Pₙ is earlier than a time point at which the mobile terminal passes an (i+1)^{th} original track point Pᵢ₊₁, and n and i are positive integers; performing a filtering process on the n original track points P₁ to Pₙ, where the filtering process one or more of deletes at least one of the n original track points P₁ to Pₙ, or updates a location of at least one of the n original track points P₁ to Pₙ; and determining a moving track of the mobile terminal on at least one road in a road map comprising a plurality of roads based on target track points that are obtained by performing the filtering process on the n original track points P₁ to Pₙ, where the road map includes a plurality of roads.

Therefore, by using the method for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

It should be understood that, a server can obtain locations of n original track points P₁ to Pₙ during the moving process of the mobile terminal, where the n original track points P₁ to Pₙ may be all or some of the several track points that are collected by a base station. For example, the server may obtain all track points that are collected by the base station, and the n original track points P₁ to Pₙ are all of the track points; or the server may process all track points, and the n original track points P₁ to Pₙ may be some of the track points that are obtained by the server by processing all the original track points.

It should be understood that, when collecting the track points during the moving process of the mobile terminal, the base station may use a same sampling time, for example, obtain, by using a same time interval, the locations of the track points at each time point, or use different sampling times, that is, collect the locations of the track points when the mobile terminal moves at different time intervals.

Optionally, in an embodiment, the filtering process in the method may include at least one of difference filtering, speed filtering, angle filtering, distortion degree filtering, trimmed mean filtering, and near-point filtering, where the speed filtering, the angle filtering, the distortion degree filtering, and the near-point filtering may be used to delete at least one of the n original track points P₁ to Pₙ, and the difference filtering and the trimmed mean filtering may be used to update a location of at least one of the n original track points P₁ to Pₙ.

With reference to the first aspect, in an implementation of the first aspect, the filtering process includes: performing difference filtering on the n original track points P₁ to Pₙ, where the difference filtering is used to rearrange points whose locations coincide, that is, update locations of coincident points.

With reference to the first aspect and the foregoing implementation thereof, in another implementation of the first aspect, the filtering process includes: obtaining a to-be-filtered points Pₓ to Pₓ₊ₐ₋₁ in the n original track points P₁ to Pₙ, where the a to-be-filtered points Pₓ to Pₓ₊ₐ₋₁ are located at a first location, and x and a are positive integers; obtaining b to-be-filtered points Pₓ₊ₐ to P_{x+a+b-1} in the n original track points P_{x+a+b} to P₁ to Pₙ, where the b to-be-filtered points Pₓ₊ₐ to P_{x+a+b-1} are located at a second location, and b is a positive integer greater than 1; obtaining c to-be-filtered points P_{x+a+b} to P_{x+a+b+c-1} in the n original track points P₁ to Pₙ, where the c to-be-filtered points P_{x+a+b} to P_{x+a+b+c-1} are located at a third location, c is a positive integer, and x+a+b+c−1 is less than or equal to n; evenly arranging to-be-filtered points P_{x+└a/2┘} to P_{x+a+└b/2┘} on a straight line from the first location to the second location; and evenly arranging to-be-filtered points P_{x+a+└b/2┘} to P_{x+a+b+└c/2┘} on a straight line from the second location to the third location, where └ ┘ indicates rounding down.

It should be understood that, when a is greater than 1, the a to-be-filtered points Pₓ to Pₓ₊ₐ₋₁ coincide completely at the first location; the b to-be-filtered points Pₓ₊ₐ to P_{x+a+b-1} coincide completely at the second location; and when c is greater than 1, the c to-be-filtered points P_{x-a+b} to P_{x+a+b+c-1} coincide completely at the third location.

It should be understood that, the evenly arranging to-be-filtered points P_{x+└a/2┘} to P_{x+a+└b/2┘} on a straight line from the first location to the second location includes: arranging the to-be-filtered point P_{x+└a/2┘} at the first location and the to-be-filtered point P_{x+a+└b/2┘} at the second location, equally dividing the straight line between the first location and the second location by distance, and arranging each to-be-filtered point between the to-be-filtered point P_{x+└a/2┘} and the to-be-filtered point P_{x+a+└b/2┘} sequentially.

It should be understood that, the evenly arranging to-be-filtered points P_{x+a+└b/2┘} to P_{x+a+b+└c/2┘} on a straight line from the second location to the third location includes: arranging the to-be-filtered point P_{x+a+└b/2┘} at the second location and the to-be-filtered point P_{x+a+b+└c/2┘} at the third location, equally dividing the straight line between the second location and the third location by distance, and arranging each to-be-filtered point between the to-be-filtered point P_{x+a+└b/2┘} and the to-be-filtered point P_{x+a+b+└c/2┘} sequentially.

Therefore, by using the difference filtering, the coincident track points may be rearranged, and locations of some of the track points may be updated, so that the track points are more evenly distributed.

With reference to the first aspect and the foregoing implementations thereof, in another implementation of the first aspect, the filtering process includes: performing speed filtering on the n original track points P₁ to Pₙ, where the speed filtering is used to filter a point with a relatively high speed, for example, filter a point of which a speed is greater than or equal to a preset speed.

With reference to the first aspect and the foregoing implementations thereof, in another implementation of the first aspect, the filtering process includes: obtaining, a speed at a first to-be-filtered point Pₐ in the n original track points P₁ to Pₙ, where a is a positive integer less than or equal to n; and deleting the first to-be-filtered point Pₐ if the speed at the first to-be-filtered point Pₐ is greater than or equal to a preset speed.

With reference to the first aspect and the foregoing implementations thereof, in another implementation of the first aspect, the obtaining the speed at the first to-be-filtered point Pₐ in the n original track points P₁ to P, includes: obtaining the first to-be-filtered point Pₐ and a second to-be-filtered point P_{b} in the n original track points P₁ to Pₙ, where b=a+1 or b=a−1, and a is less than n; and determining that an average speed in a distance from the first to-be-filtered point Pₐ to the second to-be-filtered point P_{b} is the speed at the first to-be-filtered point Pₐ.

It should be understood that, the preset speed may be set based on an actual situation, for example, may be set based on an average speed during the whole moving process of the mobile terminal, or may be set based on a speed of the mobile terminal within a specific period of time or distance, and the embodiments of this application are not limited thereto.

Therefore, by using the speed filtering, some track points with excessive erroneous speeds may be filtered out. The speeds of the track points do not conform to common sense, and are greatly different from speeds of other track points, so that the speed filtering can make remaining data more reasonable and ready.

With reference to the first aspect and the foregoing implementations thereof, in another implementation of the first aspect, the filtering process includes: performing angle filtering on the n original track points P₁ to Pₙ, where the angle filtering is used to delete vertexes of some angles that are greater than or equal to a preset angle.

With reference to the first aspect and the foregoing implementations thereof, in another implementation of the first aspect, the filtering process includes: obtaining four to-be-filtered points P_{c}, P_{c+1}, P_{c+2}, and P_{c+3} in the n original track points P₁ to Pₙ, where c is a positive integer, and c+3 is less than or equal to n; determining a first angle ∠P_{c}P_{c+1}P_{c+2} and a second angle ∠P_{c+1}P_{c+2}P_{c+3}; and deleting the to-be-filtered point P_{c+1} or the to-be-filtered point P_{c+2} in the four to-be-filtered points P_{c}, P_{c+1}, P_{c+2}, and P_{c+3} if the first angle is less than or equal to a first preset angle and the second angle is less than or equal to a second preset angle.

It should be understood that, the preset angle may be set based on an actual situation, where the first preset angle and the second preset angle may be set to be the same or different, and the embodiments of this application are not limited thereto.

Considering that when the mobile terminal moves on a road, a track of the mobile terminal is generally a relatively smooth line segment, and if there is a relatively small acute angle, it is likely to be caused by a sampling error. Therefore, a track point with a large error may be filtered out by using the angle filtering.

With reference to the first aspect and the foregoing implementations thereof, in another implementation of the first aspect, the filtering process includes: performing distortion degree filtering on the n original track points P₁ to Pₙ, where in the distortion degree filtering, some points with excessively large distortion degrees are deleted.

With reference to the first aspect and the foregoing implementations thereof, in another implementation of the first aspect, the filtering process includes: obtaining 2α+1 to-be-filtered points P_{f-α} to P_{f+α} in the n original track points P₁ to Pₙ, where f and α are positive integers, and f is greater than α; determining a distance between a to-be-filtered point P_{g} and an adjacent to-be-filtered point P_{g+1} that are in the 2α+1 to-be-filtered points P_{f-α} to P_{f+α}, where g is set to range from f−α to f+α−1, to obtain 2α distances; determining that a distance between the first to-be-filtered point P_{f-α} and the last to-be-filtered point P_{f+α} in the 2α+1 to-be-filtered points P_{f-α} to P_{f+α} is a first distance; determining that a quotient of a sum of the 2α distances and the first distance is a distortion degree; and deleting the (α+1)^{th} to-be-filtered point P_{f} in the 2α+1 to-be-filtered points P_{f-α} to P_{f+α} when the distortion degree is greater than or equal to a preset distortion degree.

The server may: traverse each point in the n original track points P₁ to Pₙ, where any track point P_{f} is used as an example herein. A half window size is set to α with the to-be-filtered point P_{f} as a center, that is, the to-be-filtered point P_{f} is centered, and α to-be-filtered points before P_{f} and α to-be-filtered points after P_{f} in the n original track points P₁ to Pₙ are obtained, to obtain a total of 2α+1 to-be-filtered points P_{f-α} to P_{f+α}. A distance between every two adjacent to-be-filtered points in the 2α+1 to-be-filtered points P_{f-α} to P_{f+α} is determined, and all the distances are summed up. A distance between the first to-be-filtered point P_{f-α} and the last to-be-filtered point P_{f+α} that are in the 2α+1 to-be-filtered points P_{f-α} to P_{f+α} is then determined, where the distance is referred to as a first distance, so that a distortion degree of the to-be-filtered point P_{f} is equal to the quotient of the sum of the 2α distances and the first distance.

It should be understood that, based on a preset distortion degree ζ, if tort(P_{f})≥ζ, the distortion degree of P_{f} is considered to be excessively large, that is, a broken line segment formed by several points that are near P_{f} is relatively distorted and has a relatively low confidence level, and P_{f} is filtered out; otherwise, P_{f} may be reserved.

Optionally, the preset distortion degree ζ may be set based on an actual situation, and generally, the distortion degree ζ is set to satisfy ζ≥1.

When the mobile terminal moves on a road network, a track of the mobile terminal should be a relatively smooth line segment, that is, a corresponding distortion degree is relatively small, in other words, approaches 1. If a serious distortion occurs, it is very likely that the serious distortion is caused by a sampling error. Therefore, filtering is performed, and by using the distortion degree filtering, some points with large errors may be filtered out.

With reference to the first aspect and the foregoing implementations thereof, in another implementation of the first aspect, the filtering process includes: performing trimmed mean filtering on the n original track points P₁ to Pₙ, where in the trimmed mean filtering, coordinates of some or all the track points may be updated.

With reference to the first aspect and the foregoing implementations thereof, in another implementation of the first aspect, the filtering process includes: obtaining 2β+1 to-be-filtered points P_{l-β} to P_{l+β} in the n original track points P₁ to Pₙ, where l and β are positive integers, and l is greater than β; determining, in the 2β+1 to-be-filtered points P_{l-β} to P_{l+β}, an average value of longitudes of all k to-be-filtered points and an average value of latitudes of all h to-be-filtered points, where k and h are positive integers less than 2β+1; and determining that the average value of the longitudes and the average value of the latitudes are respectively a longitude and a latitude that are of the (β+1)^{th} to-be-filtered point Pₗ in the 2β+1 to-be-filtered points P_{l-β} to P_{l+β}.

With reference to the first aspect and the foregoing implementations thereof, in another implementation of the first aspect, the filtering process includes: establishing a rectangular coordinate system, where the rectangular coordinate system includes an X-axis in a horizontal direction and a Y-axis in a vertical direction; determining coordinates of each of then original track points P₁ to Pₙ; obtaining 2β+1 to-be-filtered points P_{l-β} to P_{l+β} in the n original track points P₁ to Pₙ, where l and β are positive integers, and l is greater than β; determining, in the 2β+1 to-be-filtered points P_{l-β} to P_{l+β}, an average value of X-axis coordinates of k to-be-filtered points and an average value of Y-axis coordinates of h to-be-filtered points, where k and h are positive integers less than 2β+1; and determining that the average value of the X-axis coordinates and the average value of the Y-axis coordinates are respectively an X-axis coordinate and a Y-axis coordinate that are of the (β+1)^{th} to-be-filtered point Pₗ in the 2β+1 to-be-filtered points P_{l-β} to P_{l+β}.

It should be understood that, in the 2β+1 to-be-filtered points P_{l-β} to P_{l+β}, k to-be-filtered points and h to-be-filtered points are determined, where the k to-be-filtered points and the h to-be-filtered points may be consecutive or inconsecutive, a value of k may be equal to or may not be equal to a value of h, and the k to-be-filtered points and the h to-be-filtered points may be the same points or may be different points.

Optionally, for determining k to-be-filtered points in the 2β+1 to-be-filtered points P_{l-β} to P_{l+β}, all of the 2β+1 to-be-filtered points may be arranged based on magnitudes of first coordinate values, where the first coordinate may refer to the foregoing longitude value or X-axis coordinate, to-be-filtered points that correspond to maximum and minimum values are removed, and only k to-be-filtered points that correspond to intermediate values are taken; and similarly, all the to-be-filtered points are further arranged based on magnitudes of second coordinate values, where the second coordinate may refer to the foregoing latitude value or X-axis coordinate, to-be-filtered points that correspond to maximum and minimum values are removed, and only h to-be-filtered points that correspond to intermediate values are taken.

It should be understood that, the trimmed mean filtering may be performed on each of then original track points P₁ to Pₙ, or may be performed on some track points. For example, the trimmed mean filtering is only performed on some points of which coordinate value changes are relatively large. Optionally, a difference threshold may be set. When a variation of a coordinate value is less than the difference threshold, it is determined that the coordinate value change is relatively small, and the trimmed mean filtering is not performed, but the embodiments of this application are not limited thereto.

Therefore, in the trimmed mean filtering, coordinates of a current point may be adjusted with reference to locations of several points before and after the point, so that the shape of the track is smoother, and subsequent map matching is helped.

With reference to the first aspect and the foregoing implementations thereof, in another implementation of the first aspect, the filtering process includes: performing near-point filtering on the n original track points P₁ to Pₙ, where the near-point filtering is used to delete the track points that are relatively close to each other.

With reference to the first aspect and the foregoing implementations thereof, in another implementation of the first aspect, the filtering process includes: obtaining a y^{th} to-be-filtered point P_{y} and a (y+1)^{th} to-be-filtered point P_{y+1} in the n original track points P₁ to Pₙ, wherein y is a positive integer; and deleting the y^{th} to-be-filtered point P_{y} and/or the (y+1)^{th} to-be-filtered point P_{y+1} if a distance between the y^{th} to-be-filtered point P_{y} and the (y+1)^{th} to-be-filtered point P_{y+1} is less than or equal to a preset distance.

With reference to the first aspect and the foregoing implementations thereof, in another implementation of the first aspect, the filtering process includes: obtaining a (y−1)^{th} to-be-filtered point P_{y-1}, the y^{th} to-be-filtered point P_{y}, and the (y+1)^{th} to-be-filtered point P_{y+1} in the n original track points P₁ to Pₙ; and deleting the y^{th} to-be-filtered point P_{y}; otherwise, reserving the to-be-filtered points P_{y} if a distance between the (y−1)^{th} to-be-filtered point P_{y-1} and the y^{th} to-be-filtered point P_{y} is less than or equal to a preset distance, and a distance between the y^{th} to-be-filtered point P_{y} and the (y+1)^{th} to-be-filtered point P_{y+1} is also less than or equal to the preset distance.

Therefore, the near-point filtering can eliminate a positioning error caused by an excessively slow moving speed or a static status of the mobile terminal and an impact on map matching, to resolve an anchor point drift problem caused by a stay of the mobile terminal. For example, the mobile terminal may be a vehicle, the vehicle may stop or slow down during traveling, and the near-point filtering can eliminate a positioning error caused by a stopping or slowing-down process of the vehicle.

It should be understood that, the foregoing filtering may include at least one of the difference filtering, the speed filtering, the angle filtering, the distortion degree filtering, the trimmed mean filtering, and the near-point filtering. Therefore, when the filtering process includes at least two filtering procedures, n original track points P₁ to Pₙ in any non-first filtering may be obtained by renumbering remaining track points after previous filtering.

It should be understood that, with consideration of calculation complexity and accuracy, at least one filtering manner of the difference filtering, the speed filtering, the angle filtering, the distortion degree filtering, the trimmed mean filtering, and the near-point filtering may be randomly chosen. For example, because procedures of the angle filtering and the distortion degree filtering are similar, choosing to perform only one of them is acceptable. For another example, because the difference filtering is relatively complex and a probability that original track points completely overlap is relatively small, choosing not to perform the difference filtering is acceptable. For another example, with consideration of a calculation effect, if it is determined to perform the difference filtering, the difference filtering may be set to be first filtering, and then, other filtering is performed.

With reference to the first aspect and the foregoing implementations thereof, in another implementation of the first aspect, the road map is obtained, and each of the plurality of roads in the road map only includes two ends and does not include any branch road.

With reference to the first aspect and the foregoing implementations thereof, in another implementation of the first aspect, the filtering process includes: performing the filtering process on the n original track points P₁ to Pₙ to obtain m target track points, where m is a positive integer less than or equal to n.

With reference to the first aspect and the foregoing implementations thereof, in another implementation of the first aspect, the determining a moving track of the mobile terminal on at least one road in a road map based on target track points obtained by performing the filtering process on the n original track points P₁ to Pₙ includes: matching the m target track points with m points that are on the road in the road map, where the m points are arranged chronologically; and determining, based on the road occupied by the m points, the moving track of the mobile terminal on the at least one road.

With reference to the first aspect and the foregoing implementations thereof, in another implementation of the first aspect, the determining a moving track of the mobile terminal on at least one road in a road map based on target track points obtained by performing the filtering process on the n original track points P₁ to Pₙ includes: obtaining a first point and a second point that are temporally consecutive in the m points, where a time point of the first point is earlier than a time point of the second point; if the first point and the second point are located on a same road, determining that the track of the mobile terminal moves from the first point to the second point along the same road; if the first point is located on a first road, the second point is located on a second road, and the first road is different from and is connected to the second road, determining that the track of the mobile terminal moves along the first point on the first road to the second point on the second road; and if the first point is located on the first road, the second point is located on the second road, and the first road is different from and is not connected to the second road, determining a shortest path between an end point of the first road and a starting point of the second road along roads in the road map, and determining that the track of the mobile terminal moves along the first point on the first road to the end point of the first road, reaches the starting point of the second road through the shortest path, and moves to the second point on the second road by passing the starting point of the second road.

Therefore, by using the method for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

According to a second aspect, an apparatus for determining a moving track is provided, wherein the apparatus is configured to perform the method in the foregoing first aspect or any possible implementation of the first aspect. Specifically, the apparatus includes a unit configured to perform the method in the foregoing first aspect or any possible implementation of the first aspect.

According to a third aspect, an apparatus for determining a moving track is provided, including a storage unit and a processor, where the storage unit is configured to store an instruction, the processor is configured to execute the instruction stored in the memory, and when the processor executes the instruction stored in the memory, the execution enables the processor to perform the method in the first aspect or any possible implementation of the first aspect.

According to a fourth aspect, a computer-readable medium is provided, configured to store a computer program, where the computer program includes an instruction that is used to perform the method in the first aspect or any possible implementation of the first aspect.

According to a fifth aspect, a computer program product including an instruction is provided. When the instruction of the computer program product is run on a computer, the computer performs the method for determining a moving track in the foregoing first aspect or any possible implementation of the first aspect. Specifically, the computer program product can be run on the apparatus for determining a moving track in the foregoing third aspect.

### BRIEF DESCRIPTION OF DRAWINGS

FIG. 1 is a schematic flowchart of a method for determining a moving track according to an embodiment of this application;

FIG. 2 is a schematic diagram of difference filtering according to an embodiment of this application;

FIG. 3 is a schematic diagram of speed filtering according to an embodiment of this application;

FIG. 4 is a schematic diagram of angle filtering according to an embodiment of this application;

FIG. 5 is a schematic diagram of distortion degree filtering according to an embodiment of this application;

FIG. 6 is a schematic diagram of trimmed mean filtering according to an embodiment of this application;

FIG. 7 is a schematic diagram of near-point filtering according to an embodiment of this application;

FIG. 8 is a schematic diagram of a road map matching method according to an embodiment of this application;

FIG. 9 is another schematic diagram of a road map matching method according to an embodiment of this application;

FIG. 10 is a schematic block diagram of an apparatus for determining a moving track according to an embodiment of this application; and

FIG. 11 is another schematic block diagram of an apparatus for determining a moving track according to an embodiment of this application.

### DESCRIPTION OF EMBODIMENTS

The following describes technical solutions of this application with reference to accompanying drawings.

It should be understood that, the technical solutions of the embodiments of this application may be applied to various communications systems, such as: a Global System for Mobile Communications (GSM) system, a Code Division Multiple Access (CDMA) system, a Wideband Code Division Multiple Access (WCDMA) system, a general packet radio service (GPRS), a Long Term Evolution (LTE) system, an LTE frequency division duplex (FDD) system, an LTE time division duplex (TDD), Universal Mobile Telecommunications System (UMTS), or a Worldwide Interoperability for Microwave Access (WiMAX) communications system.

In the embodiments of this application, a mobile terminal may include, but is not limited to, a mobile station (MS), a mobile terminal, a mobile telephone, user equipment (UE), a handset and portable equipment, a vehicle, and the like. The mobile terminal may communicate with one or more core networks by using a radio access network (RAN). For example, the mobile terminal may be a vehicle, or may be a portable, pocket-sized, handheld, computer built-in, or in-vehicle mobile apparatus or the like.

The embodiments of this application also relate to a base station, and the base station can collect a moving track of a mobile terminal in a moving process. Optionally, an existing base station may be reused by the base station, that is, the base station may be an apparatus deployed in a radio access network to provide a wireless communication function for the terminal device. The base station may include a macro base station, a micro base station, a relay station, an access point, and the like in various forms. In systems using different radio access technologies, names of devices that have base station functions may be different. For example, in the LTE network, the device may be referred to as an evolved NodeB (eNB, or eNodeB), and in a 3rd Generation (3G) network, the device may be referred to as a NodeB (Node B).

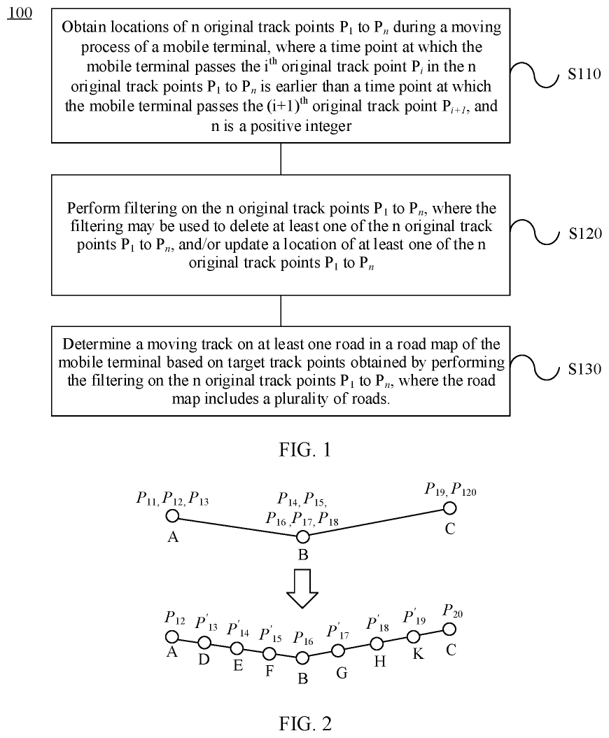

FIG. 1 is a schematic flowchart of a method 100 for determining a moving track according to an embodiment of this application. The method 100 may be performed by a server, for example, a positioning server. The positioning server can obtain data of a moving track of a terminal device collected by a base station, and perform related processing on the data. Optionally, the positioning server may alternatively be the base station, and this embodiment of this application is not limited thereto. For ease of description, description is provided below by using the method 100 performed by a server as an example.

As shown in FIG. 1, the method 100 includes S110: Obtain locations of n original track points P₁ to Pₙ during a moving process of a mobile terminal, where a time point at which the mobile terminal passes the i^{th} original track point Pᵢ in the n original track points P₁ to Pₙ is earlier than a time point at which the mobile terminal passes the (i+1)^{th} original track point Pᵢ₊₁, and n is a positive integer.

In this embodiment of this application, during the moving process of the mobile terminal, the base station may collect a moving track of the mobile terminal, to obtain locations of several track points. In S110, the server may obtain locations of n original track points P₁ to Pₙ during the moving process of the mobile terminal, where the n original track points P₁ to Pₙ may be all or some of the several track points that are collected by the base station. For example, the server may obtain all track points that are collected by the base station, and the n original track points P₁ to Pₙ are all of the track points; or the server may process all track points, and the n original track points P₁ to Pₙ may be some of the track points that are obtained by the server by processing all the original track points, and this embodiment of this application is not limited thereto.

It should be understood that, during the moving process of the mobile terminal, the mobile terminal may be located in different locations over time. The base station collects the track points during the moving process of the mobile terminal, and correspondingly, each track point includes a time point at which the mobile terminal passes the track point. The n original track points P₁ to Pₙ of the mobile terminal that are obtained by the server may be arranged based on time points at which the mobile terminal passes the original track points, for example, a time point at which the mobile terminal passes the i^{th} original track point Pᵢ in the n original track points P₁ to Pₙ is earlier than a time point at which the mobile terminal passes the (i+1)^{th} original track point Pᵢ₊₁.

It should be understood that, when collecting the track points during the moving process of the mobile terminal, the base station may use a same sampling time, for example, obtain, by using a same time interval, the locations of the track points at each time point, or use different sampling times, that is, collect the locations of the track points when the mobile terminal moves at different time intervals.

As shown in FIG. 1, the method 100 further includes S120: Perform filtering on the n original track points P₁ to Pₙ, where the filtering may be used to delete at least one of then original track points P₁ to Pₙ, and/or update a location of at least one of the n original track points P₁ to Pₙ.

Optionally, in an embodiment, the filtering may include at least one of difference filtering, speed filtering, angle filtering, distortion degree filtering, trimmed mean filtering, and near-point filtering, where the speed filtering, the angle filtering, the distortion degree filtering, and the near-point filtering may be used to delete at least one of the n original track points P 1 to Pₙ, and the difference filtering and the trimmed mean filtering may be used to update a location of at least one of the n original track points P₁ to Pₙ.

Optionally, in an embodiment, filtering is performed on the n original track points P₁ to Pₙ, and the filtering may be difference filtering. Specifically, the server obtains a to-be-filtered points Pₓ to Pₓ₊ₐ₋₁ in the n original track points P₁ to Pₙ, where the a to-be-filtered points Pₓ to Pₓ₊ₐ₋₁ are located at a first location, and x and a are positive integers, that is, when a is greater than 1, the a to-be-filtered points Pₓ to Pₓ₊ₐ₋₁ coincide completely at the first location; then obtains b to-be-filtered points Pₓ₊ₐ to P_{x+a+b-1} in the n original track points P₁ to Pₙ, where the b to-be-filtered points Pₓ₊ₐ to P_{x+a+b-1} are located at a second location, and b is a positive integer greater than 1, that is, the b to-be-filtered points Pₓ₊ₐ to P_{x+a+b-1} coincide completely at the second location; and then obtains c to-be-filtered points P_{x+a+b} to P_{x+a+b+c-1} in the n original track points P₁ to Pₙ, where the c to-be-filtered points P_{x+a+b} to P_{x+a+b+c-1} are located at a third location, c is a positive integer, and x+a+b+c−1 is less than or equal to n, that is, when c is greater than 1, the c to-be-filtered points P_{x+a+b} to P_{x+a+b+c-1} coincide completely at the third location. The first location is connected to the second location to obtain a straight line, and to-be-filtered points P_{x+└a/2┘} to P_{x+a+└b/2┘} are evenly arranged on the straight line from the first location to the second location, where a to-be-filtered point P_{x+└a/2┘} is at the first location, a to-be-filtered point P_{x+a+└b/2┘} is at the second location, the straight line between the first location and the second location is equally divided by distance, and each to-be-filtered point between the to-be-filtered point P_{x+└a/2┘} and the to-be-filtered point P_{x+a+└b/2┘} is arranged sequentially. Similarly, the second location is connected to the third location to obtain a straight line, and to-be-filtered points P_{x+a+└b/2┘} to P_{x+a+b+└c/2┘} are evenly arranged on the straight line from the second location to the third location, where a to-be-filtered point P_{x+└a/2┘} is at the second location, a to-be-filtered point P_{x+a+b+└c/2┘} is at the third location, the straight line between the second location and the third location is equally divided by distance, each to-be-filtered point between the to-be-filtered point P_{x+a+└b/2┘} and the to-be-filtered point P_{x+a+b+└c/2┘} is arranged sequentially, and └ ┘ indicates rounding down.

For example, FIG. 2 is a schematic diagram of difference filtering according to an embodiment of this application. As shown in FIG. 2, a to-be-filtered points Pₓ to Pₓ₊ₐ₋₁ that are located at the first location are obtained in the n original track points, where it is set that a=3, x=11, and the first location is a point A, that is, a to-be-filtered points are P₁₁, P₁₂, and P₁₃ located at the point A; b to-be-filtered points Pₓ₊ₐ to P_{x+a+b-1} located at the second location are obtained in the n original track points, where it is set that b=5, and the second location is a point B, that is, the b to-be-filtered points are P₁₄, P₁₅, P₁₆, P₁₇, and P₁₈ located at the point B; and c to-be-filtered points P_{x+a+b} to P_{x+a+b+c-1} located at the third location are selected from the n original track points, where it is set that c=2, and the third location is a point C, that is, the c to-be-filtered points are P₁₉ and P₂₀ located at the point C. The point A is connected to the point B to obtain a line segment AB. Based on a=3 and b=5, it can be learned that a total of five to-be-filtered points P₁₂ to P₁₆ are evenly arranged on the line segment AB. The line segment AB is divided into four segments with an equal length, to obtain five points A, D, E, F, and B as shown in FIG. 2, and the five points satisfy that AD=DE=EF=FB. An arrangement result is that: P₁₂ is at the point A, P′₁₃ is at the point D, P′₁₄ is at the point E, P′₁₅ is at the point F, and P₁₆ is at the point B, where P′₁₃ is a location of P₁₃ after movement, P′₁₄ is a location of P₁₄ after movement, and P′₁₅ is a location of P₁₅ after movement. Similarly, the point B is connected to the point C to obtain a line segment BC. Based on b=5 and c=2, it can be learned that a total of five to-be-filtered points P₁₆ to P₂₀ are evenly arranged on the line segment BC. The line segment BC is divided into four segments with an equal length, to obtain 5 points B, G, H, K, and C as shown in FIG. 2, and the five points satisfy that BG=GH=HK=KC. An arrangement result is that: P₁₆ is at the point B, P′₁₇ is at the point G, P′₁₈ is at the point H, P′₁₉ is at the point K, and P₂₀ is at the point C, where P′₁₇ is a location of P₁₇ after movement, P′₁₈ is a location of P₁₈ after movement, and P′¹⁹ is a location of P₁₉ after movement.

Therefore, by using the difference filtering, coincident points may be rearranged, and locations of some of track points may be updated, so that the track points are more evenly distributed.

Optionally, in an embodiment, filtering is performed on the n original track points P₁ to Pₙ, and the filtering may be speed filtering. Specifically, the server obtains a speed at a first to-be-filtered point Pₐ in the n original track points P₁ to Pₙ, where each track point of the n original track points P₁ to Pₙ may serve as the first to-be-filtered point Pₐ sequentially; and if the speed at the first to-be-filtered point Pₐ is greater than or equal to a preset speed, deletes the first to-be-filtered point Pₐ. Determining the speed at the first to-be-filtered point Pₐ includes that: the server may obtain the first to-be-filtered point Pₐ and a second to-be-filtered point P_{b} in the n original track points P₁ to Pₙ, where b=a+1 or b=a−1; and determine that an average speed in a distance from the first to-be-filtered point Pₐ to the second to-be-filtered point P_{b} is the speed at the first to-be-filtered point Pₐ. However, this embodiment of this application is not limited thereto.

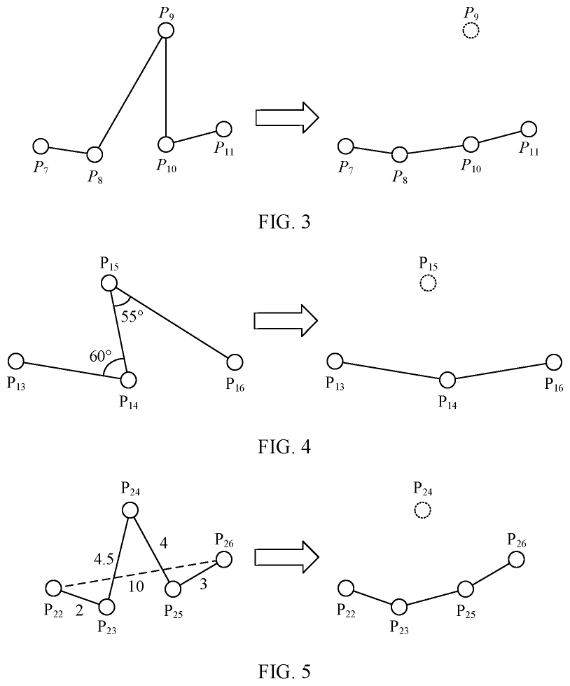

For example, FIG. 3 is a schematic diagram of speed filtering according to an embodiment of this application. As shown in FIG. 3, each track point of the n original track points P₁ to Pₙ may serve as the first to-be-filtered point Pₐ sequentially, and description is provided herein by using the first to-be-filtered point P₉ as an example. Determining a speed at P₉ may be determining that an average speed in a distance from P₈ to P₉ is the speed at P₉, or determining that an average speed in a distance from P₉ to P₁₀ is the speed at P₉. If the speed at P₉ is greater than or equal to the preset speed, as shown in FIG. 3, P₉ may be deleted; and if the speed at P₉ is less than the preset speed, P₉ is reserved.

It should be understood that, the preset speed may be set based on an actual situation, for example, may be set based on an average speed during the whole moving process of the mobile terminal, or may be set based on a speed of the mobile terminal within a specific period of time or distance, and this embodiment of this application is not limited thereto.

Therefore, by using the speed filtering, some track points with excessive erroneous speeds may be filtered out. The speeds of the track points do not conform to common sense, and are greatly different from speeds of other track points, so that the speed filtering can make remaining data more reasonable and ready.

Optionally, in an embodiment, filtering is performed on the n original track points P₁ to Pₙ, and the filtering may be angle filtering. Specifically, the angle filtering may be used to filter out a vertex of an angle that is greater than or equal to a preset angle. For example, the server may obtain four to-be-filtered points P_{c}, P_{c+1}, P_{c+2}, and P_{c+3} in the n original track points P₁ to Pₙ, where c is a positive integer, and c+3 is less than or equal to n; determine a first angle ∠P_{c}P_{c+1}P_{c+2} and a second angle ∠P_{c+1}P_{c+2}P_{c+3}; and delete the to-be-filtered point P_{c+1} or the to-be-filtered point P_{c+2} in the four to-be-filtered points P_{c}, P_{c+1}, P_{c+2}, and P_{c+3} if the first angle is less than or equal to a first preset angle and the second angle is less than or equal to a second preset angle, where the preset angle includes the first preset angle and the second preset angle.

For example, FIG. 4 is a schematic diagram of angle filtering according to an embodiment of this application. As shown in FIG. 4, four to-be-filtered points are obtained in the n original track points P₁ to Pₙ, for example, P₁₃, P₁₄, P₁₅, and P₁₆. According to FIG. 4, it can be learned that degrees of ∠P₁₃P₁₄P₁₅ and ∠P₁₄P₁₅P₁₆ are respectively measured as ∠P₁₃P₁₄P₁₅=60° and ∠P₁₄P₁₅P₁₆=55°. Assuming that both the first preset angle and the second preset angle are set to 80°, both ∠P₁₃P₁₄P₁₅ and ∠P₁₄P₁₅P₁₆ are less than the preset angle, so that P₁₄ or P₁₅ may be deleted, for example, P₁₅ may be deleted in FIG. 4.

It should be understood that, the preset angle may be set based on an actual situation, where the first preset angle and the second preset angle may be set to be the same or different, and this embodiment of this application is not limited thereto.

Considering that when the mobile terminal moves on a road, a track of the mobile terminal is generally a relatively smooth line segment, and if there is a relatively small acute angle, it is likely to be caused by a sampling error. Therefore, a track point with a relatively large error may be filtered out by using the angle filtering.

Optionally, in an embodiment, filtering is performed on the n original track points P₁ to Pₙ, and the filtering may be distortion degree filtering. Specifically, the server obtains 2α+1 to-be-filtered points P_{f-α} to P_{f+α} in the n original track points P₁ to Pₙ, where f and α are positive integers, and f is greater than α. The server determines a distance between any to-be-filtered point P_{g} and an adjacent to-be-filtered point P_{g+1} that are in the 2α+1 to-be-filtered points P_{f-α} to P_{f+α}, where each of f−α to f+α−1 serves as g separately, and a total of 2α distances can be obtained; determines that a distance between the first to-be-filtered point P_{f-α} and the last to-be-filtered point P_{f+α} in the 2α+1 to-be-filtered points P_{f-α} to P_{f+α} is a first distance; determines that a quotient of a sum of the 2α distances and the first distance is a distortion degree; and deletes the (α+1)^{th} to-be-filtered point P_{f} in the 2α+1 to-be-filtered points P_{f-α} to P_{f+α} when the distortion degree is greater than or equal to a preset distortion degree.

Specifically, the server may: traverse each point in then original track points P₁ to Pₙ, where any track point P_{f} is used as an example herein. A half window size is set to α with the to-be-filtered point P_{f} as a center, that is, the to-be-filtered point P_{f} is centered, α to-be-filtered points before P_{f} and α to-be-filtered points after P_{f} in the n original track points P₁ to Pₙ are obtained, to obtain a total of 2α+1 to-be-filtered points P_{f-α} to P_{f+α}. A distance between every two adjacent to-be-filtered points in the 2α+1 to-be-filtered points P_{f-α} to P_{f+α} is determined, and all the distances are summed up. A distance between the first to-be-filtered point P_{f-α} and the last to-be-filtered point P_{f+α} that are in the 2α+1 to-be-filtered points P_{f-α} to P_{f+α} is then determined, where the distance is referred to as a first distance, so that a distortion degree of the to-be-filtered point P_{f} is equal to the quotient of the sum of the 2α distances and the first distance. That is, the distortion degree tort(P_{f}) of the to-be-filtered point P_{f} may be calculated by using the following formula:

$$tort ( {P}_{f} ) = \frac{{\sum }_{j = f - a}^{f + a - 1} dist ( {P}_{j} , {P}_{j + 1} )}{dist ( {P}_{f - α} , {P}_{f + α} )}$$

where dist(A,B) represents calculating a distance between the point A and the point B.

It should be understood that, based on the preset distortion degree ζ, if tort(P_{f})≥ζ, the distortion degree of P_{f} is considered to be excessively large, that is, a broken line segment formed by several points that are near P_{f} is relatively distorted and has a relatively low confidence level, and P_{f} is filtered out; otherwise, P_{f} may be reserved.

Optionally, the preset distortion degree ζ may be set based on an actual situation, and the distortion degree ζ is generally set to satisfy ζ≥1. However, this embodiment of this application is not limited thereto.

For example, FIG. 5 is a schematic diagram of distortion degree filtering according to an embodiment of this application. As shown in FIG. 5, the server traverses each point in the n original track points P₁ to Pₙ, where a to-be-filtered point P₂₄ is used as an example herein. A distortion degree of P₂₄ is calculated, where the half window size is set to α=2, that is, a total of five to-be-filtered points, namely, P₂₂ to P₂₆, are obtained. It can be learned from FIG. 5 that, a distance between every two adjacent to-be-filtered points in the to-be-filtered points P₂₂ to P₂₆ is that: P₂₂P₂₃=2, P₂₃P₂₄=4.5, P₂₄P₂₅=4, and P₂₅P₂₆=3; and a distance between the first to-be-filtered point P₂₂ and the last to-be-filtered point P₂₆ that are in the five to-be-filtered points is that: P₂₂P₂₆=10. Therefore, based on the foregoing formula, it can be learned that the distortion degree of the to-be-filtered point P₂₄ is:

$$tort ( {P}_{24} ) = \frac{{P}_{22} {P}_{23} + {P}_{23} {P}_{24} + {P}_{24} {P}_{25} + {P}_{25} {P}_{26}}{{P}_{22} {P}_{26}} = \frac{2 + 4.5 + 4 + 3}{10} = 1.35 .$$

Assuming that the preset distortion degree ζ is set to 1.2, then 1.35>1.2. Therefore, as shown in FIG. 5, the to-be-filtered point P₂₄ is deleted.

When the mobile terminal moves on a road network, a track of the mobile terminal should be a relatively smooth line segment, that is, a corresponding distortion degree is relatively small, in other words, approaches 1. If a serious distortion occurs, it is very likely that the serious distortion is caused by a sampling error. Therefore, filtering is performed, and by using the distortion degree filtering, some points with large errors may be filtered out.

Optionally, in an embodiment, a filtering process is performed on the n original track points P₁ to Pₙ, and the filtering may be trimmed mean filtering. Specifically, the server obtains 2β+1 to-be-filtered points P_{l-β} to P_{l+β} in the n original track points P₁ to Pₙ, where l and β are positive integers, and l is greater than β. In the 2β+1 to-be-filtered points P_{l-β} to P_{l+β}, a location of each to-be-filtered point may be represented by at least two coordinate values. The location of each to-be-filtered point represented by two coordinate values is used as an example herein, and the two coordinates are a first coordinate and a second coordinate respectively. An average value of first coordinates of all k to-be-filtered points and an average value of second coordinates of all h to-be-filtered points are determined, where k and h are positive integers less than 2β+1. Similarly, if there are more than two coordinate values, an average values of another coordinate value may also be calculated continuously. The average value of first coordinates and the average value of second coordinates are respectively determined as a first coordinate value and a second coordinate value that are of the l^{th} to-be-filtered point Pₗ in the 2β+1 to-be-filtered points P_{l-β} to P_{l+β}.

It should be understood that, in the 2β−1 to-be-filtered points P_{l-β} to P_{l+β}, the k to-be-filtered points and the h to-be-filtered points are determined, where the k to-be-filtered points and the h to-be-filtered points may be consecutive or inconsecutive, a value of k may be equal to or may not be equal to a value of h, and the k to-be-filtered points and the h to-be-filtered points may be the same points or different points.

Optionally, for determining k to-be-filtered points in the 2β+1 to-be-filtered points P_{l-β} to P_{l+β}, all of the 2β+1 to-be-filtered points may be arranged based on magnitudes of first coordinate values, where the first coordinate may refer to the foregoing longitude value or X-axis coordinate, to-be-filtered points that correspond to maximum and minimum values are removed, and only k to-be-filtered points that correspond to intermediate values are taken; and similarly, all the to-be-filtered points are further arranged based on magnitudes of second coordinate values, where the second coordinate may refer to the foregoing latitude value or X-axis coordinate, to-be-filtered points that correspond to maximum and minimum values are removed, and only h to-be-filtered points that correspond to intermediate values are taken.

Optionally, the at least two coordinate values of each of the 2β+1 to-be-filtered points P_{l-β} to P_{l+β} may be respectively a longitude coordinate and a latitude coordinate. Specifically, in the 2β+1 to-be-filtered points P_{l-β} to P_{l+β}, an average value of longitudes of all k to-be-filtered points Pₘ to Pₘ₊ₖ₋₁ and an average value of latitudes of all h to-be-filtered points Pₘ to Pₘ₊ₕ₋₁ are determined, and the average value of the longitudes and the average value of the latitudes are respectively determined as a longitude and a latitude of the l^{th} to-be-filtered point Pₗ in the 2β+1 to-be-filtered points P_{l-β} to P_{l+β}.

Optionally, the at least two coordinate values of each of the 2β+1 to-be-filtered points P_{l-β} to P_{l+β} may be an X-axis coordinate and a Y-axis coordinate in a rectangular coordinate system, where an origin (0,0) of the rectangular coordinate system may be set at any point, that is, the rectangular coordinate system may be established with any point as a reference. Specifically, assuming that a rectangular coordinate system is established with a location of a first track point P₁ in the n original track points P₁ to Pₙ as an origin, a horizontal direction as an X axis, and a vertical direction as a Y axis. A corresponding X axis and a corresponding Y axis may be determined for each of the obtained 2β+1 to-be-filtered points P_{l-β} to P_{l+β}. An average value of X-axis coordinates of all k to-be-filtered points Pₘ to Pₘ₋ₖ₋₁ and an average value of Y-axis coordinates of all h to-be-filtered points Pₘ to Pₘ₊ₖ₋₁ are determined, and the average value of the X-axis coordinates and the average value of the Y-axis coordinates are respectively determined as an X-axis coordinate and a Y-axis coordinate of the l^{th} to-be-filtered point Pₗ in the 2β+1 to-be-filtered points P_{l-β} to P_{l+β}.

Optionally, at least two coordinate values of each of the 2β+1 to-be-filtered points P_{l-β} to P_{l+β} may further be coordinate values in another coordinate system, and details are not described herein again.

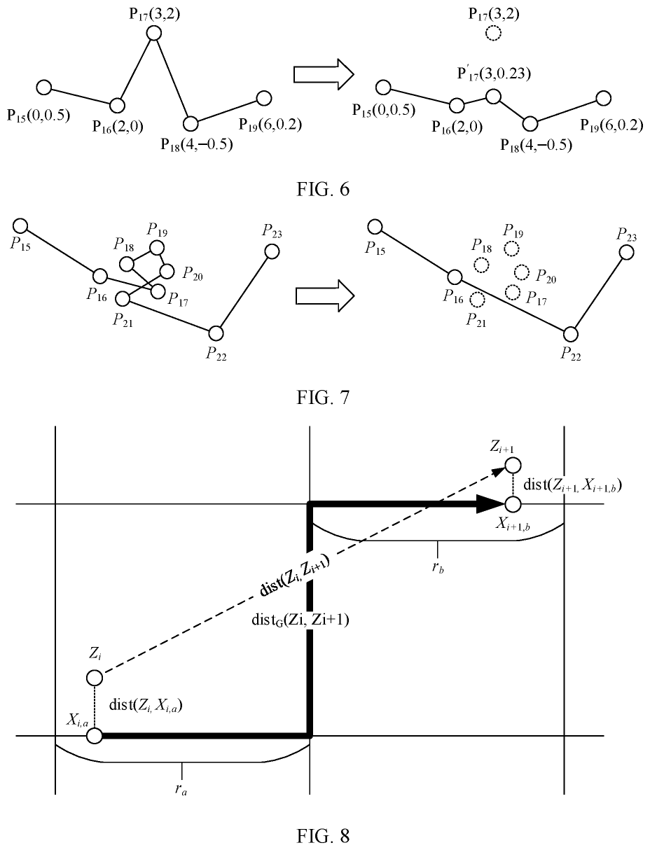

A coordinate value of a rectangular coordinate system is used as an example for description below. For example, FIG. 6 is a schematic diagram of trimmed mean filtering according to an embodiment of this application. As shown in FIG. 6, 2β+1 to-be-filtered points P_{l-β} to P_{l+β} that are obtained by a server are respectively P₁₅ to P₁₉, that is, β=2 and l=17, and the coordinate value of each to-be-filtered point is shown in FIG. 6. It is assumed that the rectangular coordinate system uses a location of P₁₄ as an origin, a horizontal direction as an X axis, and a vertical direction as a Y axis. For the X-axis coordinate, X-axis coordinates of the five to-be-filtered points are sequentially arranged as (0,2,3,4,6) by size, a trimmed value is set to 1, that is, k=3, one maximum value and one minimum value are removed, and the remaining three coordinates are (2,3,4). Similarly, for the Y-axis coordinate, Y-axis coordinates of the five to-be-filtered points are sequentially arranged as (−0.5,0,0.2,0.5,2) by size, the trimmed value herein can also be set to 1, that is, h=3, one maximum value and one minimum value are removed, and the remaining three coordinates are (0,0.2,0.5). Therefore, an X-axis average value X_{new} and a Y-axis average value Y_{new} are calculated to be:

$${X}_{new} = \frac{2 + 3 + 4}{3} = 3 , {Y}_{new} = \frac{0 + 0.2 + 0.5}{3} = 0.23 .$$

Therefore, X_{new} and Y_{new} serve as new X-axis and Y-axis coordinate values of P₁₇: (3,0.23), that is, P′₁₇ shown in FIG. 6 is an updated location.

It should be understood that, the trimmed mean filtering may be performed on each of then original track points P₁ to Pₙ, or may be performed on some track points. For example, the trimmed mean filtering is only performed on some points of which coordinate value changes are relatively large. Optionally, a difference threshold may be set. When a variation of a coordinate value is less than the difference threshold, it is determined that the coordinate value change is relatively small, and the trimmed mean filtering is not performed, but the embodiments of this application are not limited thereto.

Using the foregoing embodiment as an example, because coordinates of the original track point P₁₇ are (3,2) and after trimmed mean processing, the coordinates change to P′₁₇=(3, 0.23). It is assumed that the difference threshold is set to 0.5. Because a variation of the X-axis coordinate value is 0, a change of the Y-axis coordinate value is used as an example herein. Based on the Y-axis coordinate value 0.23 that is obtained by performing a calculation method of the trimmed mean filtering on P₁₇, it can be learned that the variation is 3−0.23=2.77, and 2.77>0.5. It can be determined to perform the trimmed mean filtering and update the coordinate value of P₁₇ to P′₁₇=(3, 0.23). Assuming the Y-axis coordinate obtained through calculation herein is 1.9 instead of 0.23, because a difference between 1.9 and the original coordinate value 2 is 0.1, and 0.1 is less than 0.5, the original coordinate value of P₁₇ can still be used by skipping performing trimmed mean filtering on the track point P₁₇.

It should be understood that, for at least two coordinate values of any to-be-filtered point Pₗ, it can be determined to update some or all of coordinate values, and this embodiment of this application is not limited thereto.

Therefore, in the trimmed mean filtering, coordinates of a current point may be adjusted with reference to locations of several points before and after the point, so that the shape of the track is smoother, and subsequent map matching is helped.

Optionally, in an embodiment, filtering is performed on the n original track points P₁ to Pₙ, and the filtering may be near-point filtering. Specifically, the server obtains the y^{th} to-be-filtered point P_{y} and the (y+1)^{th} to-be-filtered point P_{y+1} in the n original track points P₁ to Pₙ; and deletes the y^{th} to-be-filtered point P_{y} and/or the (y+1)^{th} to-be-filtered point P_{y+1} if a distance between the y^{th} to-be-filtered point P_{y} and the (y+1)^{th} to-be-filtered point P_{y+1} is less than or equal to a preset distance; otherwise, reserves the two to-be-filtered points P_{y} and P_{y+1}.

Optionally, the server may also obtain the (y−1)^{th} to-be-filtered point P_{y-1}, the y^{th} to-be-filtered point P_{y}, and the (y+1)^{th} to-be-filtered point P_{y+1} in the n original track points P₁ to Pₙ; and delete the y^{th} to-be-filtered point P_{y}; otherwise, reserve the to-be-filtered point P_{y} if a distance between the (y−1)^{th} to-be-filtered point P_{y-1} and the y^{th} to-be-filtered point P_{y} is less than or equal to a preset distance, and a distance between the y^{th} to-be-filtered point P_{y} and the (y+1)^{th} to-be-filtered point P_{y+1} is also less than or equal to the preset distance.

It should be understood that, the preset distance can be set based on an actual situation. For example, the preset distance can be set based on a moving speed of the mobile terminal and a sampling time, or the preset distance can be set based on an average value of a distance between every two adjacent points in the n original track points P₁ to Pₙ, and this embodiment of this application is not limited thereto.

For example, FIG. 7 is a schematic diagram of near-point filtering according to an embodiment of this application. As shown in FIG. 7, each of n original track points P₁ to Pₙ may be used as the y^{th} to-be-filtered point P_{y} sequentially, where the to-be-filtered points P₁₅ and P₂₃ are used as an example for description herein. A distance between every two adjacent to-be-filtered points in P₁₅ to P₂₃ is calculated separately, and it is assumed that only distances of P₁₆P₁₇, P₁₇P₁₈, P₁₈P₁₉, P₁₉P₂₀, and P₂₀P₂₁ are less than or equal to the preset distance. Using P₁₆P₁₇ as an example, both points P₁₆ and P₁₇ can be deleted, and similarly, P₁₆ to P₂₁ are deleted; or P₁₆ or P₁₇ may be deleted, if P₁₆ is deleted, P₁₆ to P₂₀ are deleted correspondingly, and if P₁₇ is deleted, P₁₇ to P₂₁ are deleted correspondingly, that is, as shown in FIG. 7, remaining points are P₁₅, P₁₆, P₂₂, and P₂₃; or adjacent to-be-filtered points whose distance is less than or equal to the preset distance in points P₁₆ and P₂₁ are deleted, that is, P₁₇ to P₂₀ are deleted.

Therefore, the near-point filtering can eliminate a positioning error caused by an excessively slow moving speed or a static status of the mobile terminal and an impact on map matching, to resolve an anchor point drift problem caused by a stay of the mobile terminal. For example, the mobile terminal may be a vehicle, the vehicle may stop or slow down during traveling, and the near-point filtering can eliminate a positioning error caused by a stopping or slowing-down process of the vehicle.

It should be understood that, the filtering in S120 may include at least one of the difference filtering, the speed filtering, the angle filtering, the distortion degree filtering, the trimmed mean filtering, and the near-point filtering. Therefore, when the filtering process includes at least two filtering procedures, n original track points P₁ to Pₙ in any non-first filtering may be obtained by renumbering remaining track points after previous filtering.

For example, using seven original track points P₁ to P₇ as an example, assuming that points P₃ and P₅ are deleted after processing is performed once, and P₆ is updated to P′₆, P₁, P₂, P₄, P′₆, and P₇ remain and are renumbered to obtain P₁, P₂, P₃ (original P₄), P₄ (original P′₆), and P₅ (original P₇), that is, serve as original track points when processing is performed next time. In other words, n original track points in the next time change to five track points P₁ to P₅.

It should be understood that, with consideration of calculation complexity and accuracy, at least one filtering manner of the difference filtering, the speed filtering, the angle filtering, the distortion degree filtering, the trimmed mean filtering, and the near-point filtering may be randomly chosen. For example, because procedures of the angle filtering and the distortion degree filtering are similar, choosing to perform only one of them is acceptable. For another example, because the difference filtering is relatively complex and a probability that original track points completely overlap is relatively small, choosing not to perform the difference filtering is acceptable. For another example, with consideration of a calculation effect, if it is determined to perform the difference filtering, the difference filtering may be set to be first filtering, and then, other filtering is performed.

Optionally, with consideration of a final calculation effect, the speed filtering, the angle filtering, the trimmed mean filtering, and the near-point filtering can be performed sequentially. Alternatively, the difference filtering, the speed filtering, the distortion degree filtering, the trimmed mean filtering, and the near-point filtering may be performed sequentially.

As shown in FIG. 1, the method 100 further includes: S130: Determine a moving track of the mobile terminal on at least one road in a road map based on target track points obtained by performing the filtering on the n original track points P₁ to Pₙ, where the road map includes a plurality of roads.

In the embodiments of this application, a server obtains the road map, and the road map includes a plurality of roads. Specifically, the road map in this embodiment of this application may use original data of various existing maps, for example, the largest open source map project OpenStreetMap, OSM for short, in the world. An original map file downloaded from the OSM official website is in an XML format; or another map format may also be used, and this embodiment of this application is not limited thereto.

In this embodiment of this application, the road map may include a plurality of roads, and the roads can be divided into several classifications, and for example, may include: a motorway (motorway), a trunk (trunk), a residential route (residential), and some unclassified roads (unclassified). If the mobile terminal is a vehicle, the plurality of roads may be divided into passable or impassable roads based on whether the vehicle can pass. For example, an ordinary vehicle cannot pass a residential-grade road.

It should be understood that, for ease of matching the moving track of the mobile terminal with the road map, the road in the original map can be segmented to obtain a road map including a plurality of roads. For example, segmentation is performed based on a direct cross point between roads, so that each road in the obtained road map is a shortest road. That is, each road is allowed to include only two nodes, namely, a start and an end, without including any branch therebetween. Optionally, each road may be bidirectional, or may be unidirectional, and this embodiment of this application is not limited thereto.

Optionally, using an original map file in the XML format downloaded from the OSM official website as an example, road segmentation is performed to obtain a road map. In the original map, a point in the map may be identified by using a node, the point may be any point in the map, and each point may have corresponding latitude and longitude information; and a broken line in the original map may further be identified by using a way, a k value may be set for each way, and when the k value is “highway”, it indicates that the way corresponds and identifies one road.

It should be understood that, based on road grades in the map, the road grades may be classified as motorway, trunk, primary, secondary, tertiary, unclassified, residential, and service in descending order. Because the last two grades (residential and service) are impassable to a vehicle, and it is assumed that the mobile terminal being the vehicle is used as an example herein, when the original map is constructed and segmented to obtain the road map, roads at the two grades may be ignored. Therefore, only a road indicating that a vehicle can pass is reserved herein, that is, the way identifies a road that a vehicle can pass in the map.

It should be understood that, the node may be used to identify any point in the original map. To obtain the road map, only a node on a road is reserved herein. In other words, a node that is on a road and that is identified by using the node in the original map is reserved. To be specific, only when two or more ways both or all pass a same node, the node is reserved and serves a node in a road network, while other nodes are only used to describe a shape of a road segment, and can be ignored herein.

In this embodiment of this application, each way is segmented, and when a node thereof is passed by a plurality of ways, the current way is segmented by the node into two road segments. In this way, segmentation is continuously performed until it is ensured that only two points, namely, a start and an end, of one road segment are passed by a plurality of ways. Specifically, a segmented road map can be obtained by using an algorithm 1 below. The algorithm 1 describes a procedure of a road map construction algorithm, where N and W respectively represent the node and the way read from the OSM; and V is a vertex set of the road map obtained after segmentation, and E is an edge set of the road map that is obtained after segmentation; and E′ is a temporary edge set and is used to record a set of road segments into which a current w is segmented. A behavior of a split(E, n) function refers to checking every edge in the edge set E, to determine whether there is a road e passing n. If there is e passing n, e is segmented, based on n, into edges e₁ and e₂.

Algorithm 1 Road network construction algorithm

| Input: OSM source file | |
|---|---|
| Output: edge set E, vertex set V | |
| 1: | N ← load_nodes(OSM) |
| 2: | W ← load_ways(OSM) |
| 3: | V = Ø, E = Ø |
| 4: | For n in N |

| | |
|---|---|
| 5: | n.visited ← FALSE |

| | |
|---|---|
| 6: | For w in W |

| | |
|---|---|
| 7: | E′ ← w |
| 8: | For n in w.nd |

| | |
|---|---|
| 9: | If n.visited == TRUE |

| | |
|---|---|
| 10: | E′ ← split(E′, n) |
| 11: | If n ∉ V |

| | |
|---|---|
| 12: | V.add(n) |
| 13: | E ← split(E, n) |

| | |
|---|---|
| 14: | Else |

| | |
|---|---|
| 15: | n.visited ← TRUE |

| | |
|---|---|
| 16: | If w is a bidirectional road |

| | |
|---|---|
| 17: | E.add(E′+ reverse(E′)) |

| | |
|---|---|
| 18: | Else |

| | |
|---|---|
| 19: | E.add(E′) |

| | |
|---|---|
| 20: | Return V, E; |

It should be understood that, the server obtains the road map that includes a plurality of roads, and matches each of target track points obtained by performing the foregoing filtering with the roads in the road map, to obtain at least one corresponding road. Specifically, m target track points are obtained by performing filtering on n original track points P₁ to Pₙ, where m is less than and equal to n. Road matching is performed between the m target track points and the road map to obtain m roads, where there may be a same road in the m roads.

Optionally, the m target track points may be, for example, matched with the roads through a plurality of algorithms, for example, with consideration of accuracy and robustness, the road matching can be performed based on a hidden Markov model (HMM), and map matching of the HMM is provided with the best accuracy and robustness. Specifically, the HMM is one of Markov chains, and the state thereof cannot be observed directly, but can be observed through an observation sequence. It is assumed that nodes O₁, O₂, . . . , Oₙ are an observed sequence. The HMM assumes that each observed sequence is generated by a corresponding hidden state, and correspondingly, H₁, H₂, . . . , Hₙ are a hidden state sequence. Each hidden state is related to a previous hidden state, but is not related to a more previous hidden state. The HMM map matching algorithm uses a real road segment corresponding to each observation point as a hidden state, the mobile terminal is regarded to transition between hidden states (that is, transition between the road segments), and each hidden state generates an observed state (that is, an actually obtained location of a target track point). A path (namely, a road segment sequence) after track matching is obtained by obtaining a hidden state sequence having a largest probability in a given observation state.

For a matching procedure of the road map, two probabilities are modeled. The first is a radiation probability (also referred to as a measurement probability), indicating a probability that one road segment matches the state from the perspective of spatial measurement. FIG. 8 is a schematic diagram of a road map matching method according to an embodiment of this application. As shown in FIG. 8, form target track points Z₁ to Zₘ obtained after filtering, any track point Zᵢ is selected, a radiation probability of a candidate road rₐ is marked as P(Zᵢ|rₐ), and the probability describes likelihood of the target track point Zᵢ on the road rₐ. Intuitively, a farther distance between the candidate road segment and a sampling point indicates a smaller possibility of actually moving on the road segment and a smaller radiation probability. Assuming that a positioning data error follows Gaussian distribution, then:

$$P ( {Z}_{i} \vert {r}_{a} ) = \frac{1}{\sqrt{2 π} σ} {e}^{- \frac{{dist ( {Z}_{a} , {X}_{i , a} )}^{2}}{2 σ}}$$

where, as shown in FIG. 8, X_{i,a} is a projection point of Zᵢ on rₐ.

The second one that is modeled is a transition probability. Any target track point Zᵢ has a series of candidate matching road segments, for example, roads rₐ, r_{b} . . . . The transition probability refers to a probability of transitioning from a current state to a next state. Intuitively, an actual driving path is usually close to a shortest path as much as possible. Therefore, a larger difference between a distance on the road and the shortest distance indicates a lower transition probability.

A candidate matching road of any target track point Zᵢ is the road segment rₐ. A candidate matching road of a next target track point Zᵢ₊₁ of the target track point Zᵢ is the road segment r_{b}. X_{i+1,b} is marked as a projection point of the target track point Zᵢ₊₁ on the road segment r_{b}, and then a probability of transitioning from rₐ that matches Zᵢ to r_{b} matches Zᵢ₊₁ is:

$$P ( {r}_{b} \vert {r}_{a} , {Z}_{i} , {Z}_{i + 1} ) = \frac{1}{β} {e}^{- {δ}_{i} / β}$$

wherein δᵢ−|dist(Zᵢ,Zᵢ₊₁)−dist_{G}(X_{i,a},X_{i+1,b})|; dist(Zᵢ,Zᵢ₊₁) is an actual distance between the target track point Zᵢ and Zᵢ₊₁; and dist_{G}(X_{i,a},X_{i+1,b}) is a distance between X_{i,a} and X_{i+1,b} on the road, that is, a length of a gray broken line from X_{i,a} to X_{i+1,b} in FIG. 8.

For a to-be-matched track, that is, m target track points Z=Z₁→Z₂→ . . . →Zₘ, m corresponding road segments R*=r₁,r₂, . . . , rₘ that are found through matching should satisfy:

R*=arg max_{R}P(R|Z)

P(R|Z) is expanded, and a first-order Markov property of the Markov chain is used, including:

$$P ( R \vert Z ) ∝ P ( Z \vert R ) P ( R ) = P ( {Z}_{1} , {Z}_{2} , … , {Z}_{m} \vert {r}_{1} , {r}_{2} , … , {r}_{m} ) P ( {r}_{1} , {r}_{2} , … , {r}_{m} ) = \prod P ( {Z}_{i} \vert {r}_{i} ) \prod P ( {r}_{j} \vert {r}_{i} ) .$$

P(zᵢ|rᵢ) is a radiate probability and P(rⱼ|rⱼ) is a transition probability. A state sequence R can be obtained by using the Viterbi algorithm, so that a posterior probability of the entire sequence is the largest, and the sequence R corresponds to m roads that correspond to m target track points.

In this embodiment of this application, m roads are obtained based on the m target track points; and a moving track of the mobile terminal on the road map is determined based on the m roads. For the obtained m roads, the moving track of the mobile terminal on the road map may be determined by using a plurality of algorithms. For example, the moving track may be determined by using the following method. Using adjacent target track points Zᵢ and Zᵢ₊₁ as an example herein, an actual traveling path of the mobile terminal corresponding to the target track points Zᵢ and Zᵢ₊₁ is determined, where a matched road of Zᵢ is marked as rᵢ, and a matched road of Zᵢ₊₁ is marked as rᵢ₊₁; and an actual road path, determined by the server, along which the mobile terminal moves from Zᵢ to Zᵢ₊₁ is marked as Rᵢ.

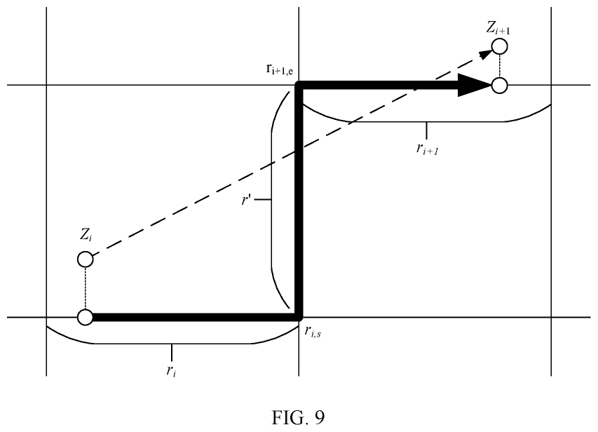

If rᵢ=rᵢ₊₁, that is, the road rᵢ and the road rᵢ₊₁ are a same road, Rᵢ={rᵢ}, in other words, the mobile terminal always moves on the road rᵢ. If rᵢ≠rᵢ₊₁, and rᵢ is adjacent to rᵢ₊₁, that is, the road rᵢ and the road rᵢ₊₁ are not a same road, but when the road rᵢ is connected to the road rᵢ₊₁ end to end, Rᵢ={rᵢ, rᵢ₊₁}, in other words, the moving track of the mobile terminal is from the road rᵢ to the road rᵢ₊₁. If rᵢ≠rᵢ₊₁, and rᵢ is not adjacent to rᵢ₊₁, that is, the road rᵢ and the road rᵢ₊₁ are not the same road, and the road rᵢ is not connected to the road rᵢ₊₁, an end of the road rᵢ is determined and marked as r_{i,s}, and a start of the road rᵢ₊₁ is determined and marked as r_{i+1,e}. Based on r_{i,s} and r_{i+1,e}, a shortest road path from r_{i,s} to r_{i+1,e} is determined and marked as r′, Rᵢ={rᵢ}+r′+{rᵢ₊₁}. For example, as shown in FIG. 9, based on locations of r_{i,s} and r_{i+1,e}, the shortest road path from r_{i,s} to r_{i+1,e} is r′ shown in the figure. Therefore, the moving track of the mobile terminal is from the road rᵢ to the shortest road path r′, and then to the road rᵢ₊₁, for example, the path shown by the gray line segment in FIG. 9.

By analogy, the m roads corresponding to the m target track points are matched based on the foregoing manner, to obtain at least one consecutive road, that is, the moving track of the mobile terminal on the road map.

Therefore, by using the method for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

It should be understood that sequence numbers of the foregoing processes do not mean execution sequences in various embodiments of this application. The execution sequences of the processes should be determined according to functions and internal logic of the processes, and should not be construed as any limitation on the implementation processes of the embodiments of this application.

In addition, the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

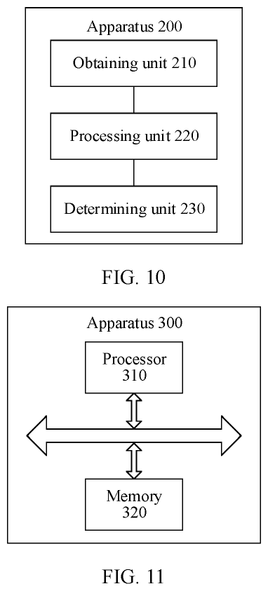

The method for determining a moving track according to this embodiment of this application is described above in detail with reference to FIG. 1 to FIG. 9. An apparatus for determining a moving track according to this embodiment of this application are described below with reference to FIG. 10 to FIG. 11.

As shown in FIG. 10, an apparatus 200 for determining a moving track according to this embodiment of this application includes an obtaining unit 210, a processing unit 220, and a determining unit 230.

The obtaining unit 210 is configured to obtain locations of n original track points P₁ to Pₙ during a moving process of a mobile terminal, where a time point at which the mobile terminal passes the i^{th} original track point Pᵢ in the n original track points P₁ to Pₙ is earlier than a time point at which the mobile terminal passes the (i+1)^{th} original track point Pᵢ₊₁, and n is a positive integer.

The processing unit 220 is configured to perform filtering on the n original track points P₁ to Pₙ, where the filtering is used to delete at least one of the n original track points P₁ to Pₙ, and/or update a location of at least one of the n original track points P₁ to Pₙ.

The determining unit 230 is configured to determine a moving track of the mobile terminal on at least one road in a road map based on target track points obtained by performing the filtering on the n original track points P₁ to Pₙ, where the road map includes a plurality of roads.

Therefore, by using the apparatus for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

Optionally, the processing unit 220 is configured to: obtain a to-be-filtered points Pₓ to Pₓ₊ₐ₋₁ in the original track points P₁ to Pₙ, where the a to-be-filtered points Pₓ to Pₓ₊ₐ₋₁ are located at a first location, x and a are positive integers; obtain b to-be-filtered points Pₓ₊ₐ to P_{x+a+b-1} in the n original track points P₁ to Pₙ, where the b is to-be-filtered points Pₓ₊ₐ to P_{x+a+b-1} are located at a second location, b is a positive integer greater than 1; obtain c to-be-filtered points P_{x+a+b} to P_{x+a+b+c-1} in the n original track points P₁ to Pₙ, where the c to-be-filtered points P_{x+a+b} to P_{x+a+b+c-1} are located at a third location, c is a positive integer, and x+a+b+c−1 is less than or equal to n; evenly arrange to-be-filtered points P_{x+└a/2┘} to P_{x+a+└b/2┘} on a straight line from the first location to the second location; and evenly arrange to-be-filtered points P_{x+a+└b/2┘} to P_{x+a+b+└c/2┘} on a straight line from the second location to the third location, where └ ┘ indicates rounding down.

Optionally, the processing unit 220 is configured to: obtain a speed at a first to-be-filtered point Pₐ in the n original track points P₁ to Pₙ, where a is a positive integer less than or equal to n; and delete the first to-be-filtered point Pₐ if the speed at the first to-be-filtered point Pₐ is greater than or equal to a preset speed.

Optionally, the processing unit 220 is configured to: obtain the first to-be-filtered point Pₐ and a second to-be-filtered point P_{b} in the n original track points P₁ to Pₙ, where b=a+1 or b=a−1, and a is less than n; and determine that an average speed in a distance from the first to-be-filtered point Pₐ to the second to-be-filtered point P_{b} is the speed at the first to-be-filtered point Pₐ.

Optionally, the processing unit 220 is configured to: obtain four to-be-filtered points P_{c}, P_{c+1}, P_{c+2}, and P_{c+3} in the n original track points P₁ to Pₙ, where c is a positive integer, and c+3 is less than or equal to n; determine a first angle ∠P_{c}P_{c+1}P_{c+2} and a second angle ∠P_{c+1}P_{c+2}P_{c+3}; and delete the to-be-filtered point P_{c+1} or the to-be-filtered point P_{c+2} in the four to-be-filtered points P_{c}, P_{c+1}, P_{c+2}, and P_{c+3} if the first angle is less than or equal to a first preset angle and the second angle is less than or equal to a second preset angle.

Optionally, the processing unit 220 is configured to: obtain 2α+1 to-be-filtered points P_{f-α} to P_{f+α} in the n original track points P₁ to Pₙ, where f and α are positive integers, and f is greater than α; determine a distance between a to-be-filtered point P_{g} and an adjacent to-be-filtered point P_{g+1} that are in the 2α+1 to-be-filtered points P_{f-α} to P_{f+α}, where g is set to range from f−α to f+α−1, to obtain 2α distances; determine that a distance between the first to-be-filtered point P_{f-α} and the last to-be-filtered point P_{f+α} that are in the 2α+1 to-be-filtered points P_{f-α} to P_{f+α} is a first distance; determine that a quotient of a sum of the 2α distances and the first distance is a distortion degree; and delete the (a+1)^{th} to-be-filtered point P_{f} in the 2α+1 to-be-filtered points P_{f-α} to P_{f+α} when the distortion degree is greater than or equal to a preset distortion degree.

Optionally, the processing unit 220 is configured to: obtain 2β+1 to-be-filtered points P_{l-β} to P_{l+β} in the n original track points P₁ to Pₙ, where l and β are positive integers and l is greater than β; determine, in the 2β+1 to-be-filtered points P_{l-β} to P_{l+β}, an average value of longitudes of all k to-be-filtered points and an average value of latitudes of all h to-be-filtered points, where k and h are positive integers less than 2β+1; and respectively determine the average value of the longitudes and the average value of the latitudes as a longitude and a latitude of the (β+1)^{th} to-be-filtered point Pᵢ in the 2β+1 to-be-filtered points P_{l-β} to P_{l+β}.

Optionally, the processing unit 220 is configured to: obtain the y^{th} to-be-filtered point P_{y} and the (y+1)^{th} to-be-filtered point P_{y+1} in the n original track points P₁ to Pₙ; and delete the y^{th} to-be-filtered point P_{y} and/or the (y+1)^{th} to-be-filtered point P_{y+1} if a distance between the y^{th} to-be-filtered point P_{y} and the (y+1)^{th} to-be-filtered point P_{y+1} is less than or equal to a preset distance.

It should be understood that, the apparatus 200 for determining a moving track according to this embodiment of this application may correspond to performing the method 100 in the embodiments of this application, and in the apparatus 200, the foregoing and other operations and/or functions of units are respectively performed for corresponding procedures of the server in each method in FIG. 1 to FIG. 9. For brevity, details are not described herein again.

Therefore, by using the apparatus for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

FIG. 11 is a schematic block diagram of an apparatus 300 for determining a moving track according to an embodiment of this application. As shown in FIG. 11, the apparatus 300 includes a processor 310. Optionally, the apparatus 300 further includes a memory 320, and the memory 320 is connected to the processor 310. The processor 310 and the memory 320 may communicate with each other through an inner connection path, to transfer and/or control a data signal. The memory 320 may be configured to store an instruction, the processor 310 is configured to perform the instruction stored in the memory 320, and the processor 310 is further configured to: obtain locations of n original track points P₁ to Pₙ during a moving process of a mobile terminal, where a time point at which the mobile terminal passes the i^{th} original track point Pᵢ in the n original track points P₁ to Pₙ is earlier than a time point at which the mobile terminal passes the (i+1)^{th} original track point Pᵢ₊₁, and n is a positive integer; perform filtering on the n original track points P₁ to Pₙ, where the filtering is used to delete at least one of the n original track points P₁ to Pₙ, and/or update a location of at least one of the n original track points P₁ to Pₙ; and determine a moving track of the mobile terminal on at least one road in a road map based on target track points obtained by performing the filtering on the n original track points P₁ to Pₙ, where the road map includes a plurality of roads.

Therefore, by using the apparatus for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

Optionally, in an embodiment, the processor 310 is configured to: obtain a to-be-filtered points Pₓ to Pₓ₊ₐ₋₁ in the n original track points P₁ to Pₙ, where the a to-be-filtered points Pₓ to Pₓ₊ₐ₋₁ are located at a first location, and x and a are positive integers; obtain b to-be-filtered points Pₓ₊ₐ to P_{x+a+b-1} in the n original track points P₁ to Pₙ, where the b to-be-filtered points Pₓ₊ₐ to P_{x+a+b-1} are located at a second location, and b is a positive integer greater than 1; obtain c to-be-filtered points P_{x+a+b} to P_{x+a+b+c-1} in the n original track points P₁ to Pₙ, where the c to-be-filtered points P_{x+a+b} to P_{x+a+b+c-1} are located at a third location, c is a positive integer, and x+a+b+c−1 is less than or equal to n; evenly arrange to-be-filtered points P_{x+└a/2┘} to P_{x+a+└b/2┘} on a straight line from the first location to the second location; and evenly arrange to-be-filtered points P_{x+a+└b/2┘} to P_{x+a+b+└c/2┘} on a straight line from the second location to the third location, where └ ┘ indicates rounding down.

Optionally, in an embodiment, the processor 310 is configured to: obtain a speed at a first to-be-filtered point Pₐ in the n original track points P₁ to Pₙ, where a is a positive integer less than or equal to n; and delete the first to-be-filtered point Pₐ if the speed at the first to-be-filtered point Pₐ is greater than or equal to a preset speed.

Optionally, in an embodiment, the processor 310 is configured to: obtain the first to-be-filtered point Pₐ and a second to-be-filtered point P_{b} in the n original track points P₁ to Pₙ, where b=a+1 or b=a−1, and a is less than n; and determine that an average speed in a distance from the first to-be-filtered point Pₐ to the second to-be-filtered point P_{b} is the speed at the first to-be-filtered point Pₐ.

Optionally, in an embodiment, the processor 310 is configured to: obtain four to-be-filtered points P_{c}, P_{c+1}, P_{c+2}, and P_{c+3} in the n original track points P₁ to Pₙ, where c is a positive integer, and c+3 is less than or equal to n; determine a first angle ∠P_{c}P_{c+1}P_{c+2} and a second angle ∠P_{c+1}P_{c+2}P_{c+3}; and delete the to-be-filtered point P_{c+1} or the to-be-filtered point P_{c+2} in the four to-be-filtered points P_{c}, P_{c+1}, P_{c+2}, and P_{c+3} if the first angle is less than or equal to a first preset angle and the second angle is less than or equal to a second preset angle.

Optionally, in an embodiment, the processor 310 is configured to: obtain 2α+1 to-be-filtered points P_{f-α} to P_{f+α} in the n original track points P₁ to Pₙ, where f and α are positive integers, and f is greater than α; determine a distance between a to-be-filtered point P_{g} and an adjacent to-be-filtered point P_{g+1} that are in the 2α+1 to-be-filtered points P_{f-α} to P_{f+α}, where g is set to range from f−α to f+α−1, to obtain 2α distances; determine that a distance between the first to-be-filtered point P_{f-α} and the last to-be-filtered point P_{f+α} that are in the 2α+1 to-be-filtered points P_{f-α} to P_{f+α} is a first distance; determine that a quotient of a sum of the 2α distances and the first distance is a distortion degree; and delete the (α+1)^{th} to-be-filtered point P_{f} in the 2α+1 to-be-filtered points P_{f-α} to P_{f+α} when the distortion degree is greater than or equal to a preset distortion degree.

Optionally, in an embodiment, the processor 310 is configured to: obtain 2β+1 to-be-filtered points P_{l-β} to P_{l+β} in the n original track points P₁ to Pₙ, where l and β are positive integers, and l is greater than β; determine, in the 2β+1 to-be-filtered points P_{l-β} to P_{l+β}, an average value of longitudes of all k to-be-filtered points and an average value of latitudes of all h to-be-filtered points, where k and h are positive integers less than 2β+1; and determine that the average value of the longitudes and the average value of the latitudes are respectively a longitude and a latitude that are of the (β+1)^{th} to-be-filtered point Pₗ in the 2β+1 to-be-filtered points P_{l-β} to P_{l+β}.

Optionally, in an embodiment, the processor 310 is configured to: obtain a y^{th} to-be-filtered point P_{y} and a (y+1)^{th} to-be-filtered point P_{y+1} in the n original track points P₁ to Pₙ; and delete the y^{th} to-be-filtered point P_{y} and/or the (y+1)^{th} to-be-filtered point P_{y+1} if a distance between the y^{th} to-be-filtered point P_{y} and the (y+1)^{th} to-be-filtered point P_{y+1} is less than or equal to a preset distance.

It should be understood that, the apparatus 300 for determining a moving track according to this embodiment of this application may correspond to the apparatus 200 in the embodiments of this application, and may correspond to a corresponding execution body in the method 100 according to the embodiments of this application, and the foregoing and other operations and/or functions of the units of the apparatus 300 are respectively intended to implement corresponding procedures of the server in the methods in FIG. 1 to FIG. 9. For brevity, details are not described herein again.

Therefore, by using the apparatus for determining a moving track in the embodiments of this application, at least one type of filtering is performed on the n original track points during the moving process of the mobile terminal, to obtain m target points; and road map matching is further performed on the m target track points, to obtain the moving track of the mobile terminal, so that a track point that has a relatively large error and that produces a negative effect in the original track points can be filtered out or changed, thereby allowing the processed target track points to be more accurate during the map matching. In particular, for a high-noise data obtaining manner, such as base station positioning, and a special situation such as quick positioning, the subsequent map matching procedure is more accurate and the obtained moving track is closer to an actual situation.

It should be noted that the foregoing method embodiment of this application may be applied to a processor, or implemented by a processor. The processor may be an integrated circuit chip and has a signal processing capability. In an implementation process, steps in the foregoing method embodiments can be implemented by using a hardware integrated logical circuit in the processor, or by using instructions in a form of software. The processor may be a general purpose processor, a digital signal processor (DSP), an application specific integrated circuit (ASIC), a field programmable gate array (FPGA) or another programmable logical device, a discrete gate or transistor logic device, or a discrete hardware component. It may implement or perform the methods, the steps, and logical block diagrams that are disclosed in the embodiments of this application. The general purpose processor may be a microprocessor, or the processor may be any conventional processor or the like. Steps of the methods disclosed with reference to the embodiments of this application may be directly executed and accomplished by means of a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, a register, or the like. The storage medium is located in the memory, and a processor reads information in the memory and completes the steps in the foregoing methods in combination with hardware of the processor.

It may be understood that the memory in the embodiments of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (Electrically EPROM, EEPROM), or a flash memory. The volatile memory may be a random access memory (RAM), used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). It should be noted that the memory of the systems and methods described in this specification includes but is not limited to these and any memory of another proper type.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for determining a moving track, the method comprising:
obtaining locations of n original track points P₁ to Pₙ during a moving process of a mobile terminal, wherein a time point at which the mobile terminal passes an i^{th} original track point P, in the n original track points P₁ to Pₙ is earlier than a time point at which the mobile terminal passes an (i+1)^{th} original track point Pᵢ₊₁, and n and i are positive integers;
performing a filtering process on the n original track points P₁ to Pₙ, wherein the filtering process one or more of:
deletes at least one of the n original track points P₁ to Pₙ, or
updates a location of at least one of then original track points P₁ to Pₙ; and
determining a moving track of the mobile terminal on at least one road included in a road map comprising a plurality of roads based on target track points obtained by performing the filtering process on the n original track points P₁ to Pₙ.

2. The method according to claim 1, wherein the filter process comprises:
obtaining a to-be-filtered points Pₓ to Pₓ₊ₐ₋₁ in the n original track points P₁ to Pₙ, wherein the a to-be-filtered points Pₓ to Pₓ₊ₐ₋₁ are located at a first location, and x and a are positive integers;
obtaining b to-be-filtered points Pₓ₊ₐ to P_{x+a+b-1} in the n original track points P₁ to Pₙ, wherein the b to-be-filtered points Pₓ₊ₐ to P_{x+a+b-1} are located at a second location, and b is a positive integer greater than 1;
obtaining c to-be-filtered points P_{x+a+b} to P_{x+a+b+c-1} in the n original track points P₁ to Pₙ, wherein the c to-be-filtered points P_{x+a+b} to P_{x+a+b+c-1} are located at a third location, c is a positive integer, and x+a+b+c−1 is less than or equal to n;
evenly arranging to-be-filtered points P_{x+└a/2┘} to P_{x+a+└b/2┘} on a straight line from the first location to the second location; and
evenly arranging to-be-filtered points P_{x+a+└b/2┘} to P_{x+a+b+└c/2┘} on a straight line from the second location to the third location, wherein └ ┘ indicates rounding down.

3. The method according to claim 1, wherein the filtering process comprises:
obtaining a speed at a first to-be-filtered point Pₐ in the n original track points P₁ to Pₙ, wherein a is a positive integer less than or equal to n; and
deleting the first to-be-filtered point Pₐ based on a determination that the speed at the first to-be-filtered point Pₐ is greater than or equal to a preset speed.

4. The method according to claim 3, wherein the obtaining the speed at the first to-be-filtered point Pₐ in the n original track points P₁ to Pₙ comprises:
obtaining the first to-be-filtered point Pₐ and a second to-be-filtered point P_{b} in the n original track points P₁ to Pₙ, wherein b=a+1 or b=a−1, and a is less than n; and
determining that an average speed in a distance from the first to-be-filtered point Pₐ to the second to-be-filtered point P_{b} is the speed at the first to-be-filtered point Pₐ.

5. The method according to claim 1, wherein the filtering process comprises:
obtaining four to-be-filtered points P_{c}, P_{c+1}, P_{c+2}, and P_{c+3} in the n original track points P₁ to Pₙ, wherein c is a positive integer, and c+3 is less than or equal to n;
determining a first angle ∠P_{c}P_{c+1}P_{c+2} and a second angle ∠P_{c+1}P_{c+2}P_{c+3}; and
deleting the to-be-filtered point P_{c+1} or the to-be-filtered point P_{c+2} in the four to-be-filtered points P_{c}, P_{c+1}, P_{c+2}, and P_{c+3} based on a determination that the first angle is less than or equal to a first preset angle and the second angle is less than or equal to a second preset angle.

6. The method according to claim 1, wherein the filtering process comprises:
obtaining 2α+1 to-be-filtered points P_{f-α} to P_{f+α} in the n original track points P₁ to Pₙ, wherein f and α are positive integers, and f is greater than α;
determining a distance between a to-be-filtered point P_{g} and an adjacent to-be-filtered point P_{g+1} that are in the 2α+1 to-be-filtered points P_{f-α} to P_{f+α}, wherein g is set to range from f−α to f+α−1, to obtain 2α distances;
determining that a distance between the first to-be-filtered point P_{f-α} and a last to-be-filtered point P_{f+α} in the 2α+1 to-be-filtered points P_{f-α} to P_{f+α} is a first distance;
determining that a quotient of a sum of the 2α distances and the first distance is a distortion degree; and
deleting the (α+1)^{th} to-be-filtered point P_{f} in the 2α+1 to-be-filtered points P_{f-α} to P_{f+α} based on a determination that the distortion degree is greater than or equal to a preset distortion degree.

7. The method according to claim 1, wherein the filtering process comprises:
obtaining 2β+1 to-be-filtered points P_{l-β} to P_{l+β} in the n original track points P₁ to Pₙ, wherein l and β are positive integers, and l is greater than β;
determining, in the 2β+1 to-be-filtered points P_{l-β} to P_{l+β}, an average value of longitudes of all k to-be-filtered points and an average value of latitudes of all h to-be-filtered points, wherein k and h are positive integers less than 2β+1; and
determining that the average value of the longitudes and the average value of the latitudes are respectively a longitude and a latitude that are of the (β+1)^{th} to-be-filtered point Pₗ in the 2β+1 to-be-filtered points P_{l-β} to P_{l+β}.

8. The method according to claim 1, wherein the filtering process comprises:
obtaining a y^{th} to-be-filtered point P_{y} and a (y+1)^{th} to-be-filtered point P_{y+1} in the n original track points P₁ to Pₙ, wherein y is a positive integer; and
deleting one or more of the y^{th} to-be-filtered point P_{y} or the (y+1)^{th} to-be-filtered point P_{y+1} based on a determination that a distance between the y^{th} to-be-filtered point P_{y} and the (y+1)^{th} to-be-filtered point P_{y+1} is less than or equal to a preset distance.

9. An apparatus for determining a moving track, the apparatus comprising a processor and a memory having computer-readable instructions stored thereon that, when executed by the processor, cause the apparatus to:
obtain locations of n original track points P₁ to Pₙ, where n is a positive integer, during a moving process of a mobile terminal, wherein a time point at which the mobile terminal passes an i^{th} original track point Pᵢ in the n original track points P₁ to Pₙ is earlier than a time point at which the mobile terminal passes an (i+1)^{th} original track point Pᵢ₊₁, and n and i are positive integers;
perform a filtering process on the n original track points P₁ to Pₙ, wherein the filtering process one or more of:
deletes at least one of the n original track points P₁ to Pₙ, or
updates a location of at least one of then original track points P₁ to Pₙ; and
determine a moving track of the mobile terminal on at least one road included in a road map comprising a plurality of roads based on target track points obtained by performing the filtering process on the n original track points P₁ to Pₙ.

10. The apparatus according to claim 9, wherein the apparatus is further caused to:
obtain a to-be-filtered points Pₓ to Pₓ₊ₐ₋₁ in the n original track points P₁ to Pₙ, wherein the a to-be-filtered points Pₓ to Pₓ₊ₐ₋₁ are located at a first location, and x and a are positive integers;
obtain b to-be-filtered points Pₓ₊ₐ to P_{x+a+b-1} in the n original track points P₁ to Pₙ, wherein the b to-be-filtered points Pₓ₊ₐ to P_{x+a+b-1} are located at a second location, and b is a positive integer greater than 1;
obtain c to-be-filtered points P_{x+a+b} to P_{x+a+b+c-1} in the n original track points P₁ to Pₙ, wherein the c to-be-filtered points P_{x+a+b} to P_{x+a+b+c-1} are located at a third location, c is a positive integer, and x+a+b+c−1 is less than or equal to n;
evenly arrange to-be-filtered points P_{x-└a/2┘} to P_{x+a-└b/2┘} on a straight line from the first location to the second location; and
evenly arrange to-be-filtered points P_{x+a+└b/2┘} to P_{x+a+b+└c/2┘} on a straight line from the second location to the third location, wherein └ ┘ indicates rounding down.

11. The apparatus according to claim 9, wherein the apparatus is further caused to:
obtain a speed at a first to-be-filtered point Pₐ in the n original track points P₁ to Pₙ, wherein a is a positive integer less than or equal to n; and
delete the first to-be-filtered point Pₐ based on a determination that the speed at the first to-be-filtered point Pₐ is greater than or equal to a preset speed.

12. The apparatus according to claim 11, wherein the apparatus is further caused to:
obtain the first to-be-filtered point Pₐ and a second to-be-filtered point P_{b} in the n original track points P₁ to Pₙ, wherein b=a+1 or b=a−1, and a is less than n; and
determine that an average speed in a distance from the first to-be-filtered point Pₐ to the second to-be-filtered point P_{b} is the speed at the first to-be-filtered point Pₐ.

13. The apparatus according to claim 9, wherein the processor is configured to:
obtain four to-be-filtered points P_{c}, P_{c+1}, P_{c+2}, and P_{c+3} in then original track points P₁ to Pₙ, wherein c is a positive integer, and c+3 is less than or equal to n;
determine a first angle ∠P_{c}P_{c+1}P_{c+2} and a second angle ∠P_{c+1}P_{c+2}P_{c+3}; and
delete the to-be-filtered point P_{c+1} or the to-be-filtered point P_{c+2} in the four to-be-filtered points P_{c}, P_{c+1}, P_{c+2}, and P_{c+3} based on a determination that the first angle is less than or equal to a first preset angle and the second angle is less than or equal to a second preset angle.

14. The apparatus according to claim 9, wherein the apparatus is further caused to:
obtain 2α+1 to-be-filtered points P_{f-α} to P_{f+α} in the n original track points P₁ to Pₙ, wherein f and α are positive integers, and f is greater than α;
determine a distance between a to-be-filtered point P_{g} and an adjacent to-be-filtered point P_{g+1} that are in the 2α+1 to-be-filtered points P_{f-α} to P_{f+α}, wherein g is set to range from f−α to f+α−1, to obtain 2α distances;
determine that a distance between the first to-be-filtered point P_{f-α} and a last to-be-filtered point P_{f+α} in the 2α+1 to-be-filtered points P_{f-α} to P_{f+α} is a first distance;
determine that a quotient of a sum of the 2α distances and the first distance is a distortion degree; and
delete the (α+1)^{th} to-be-filtered point P_{f} in the 2α+1 to-be-filtered points P_{f-α} to P_{f+α} based on a determination that the distortion degree is greater than or equal to a preset distortion degree.

15. The apparatus according to claim 9, wherein the apparatus is further caused to:
obtain 2β+1 to-be-filtered points P_{l-β} to P_{l+β} in the n original track points P ₁ to Pₙ, wherein l and β are positive integers, and l is greater than β;
determine, in the 2β+1 to-be-filtered points P_{l-β} to P_{l+β}, an average value of longitudes of all k to-be-filtered points and an average value of latitudes of all h to-be-filtered points, wherein k and h are positive integers less than 2β+1; and
determine that the average value of the longitudes and the average value of the latitudes are respectively a longitude and a latitude that are of the (β+1)^{th} to-be-filtered point Pₗ in the 2β+1 to-be-filtered points P_{l-β} to P_{l+β}.

16. The apparatus according to claim 9, wherein the apparatus is further caused to:
obtain a y^{th} to-be-filtered point P_{y} and a (y+1)^{th} to-be-filtered point P_{y+1} in the n original track points P₁ to Pₙ, wherein y is a positive integer; and
delete one or more of the y^{th} to-be-filtered point P_{y} or the (y+1)^{th} to-be-filtered point P_{y+1} based on a determination that a distance between the y^{th} to-be-filtered point P_{y} and the (y+1)^{th} to-be-filtered point P_{y+1} is less than or equal to a preset distance.

17. A non-transitory computer-readable medium having instructions stored thereon that, when executed by a processor, cause an apparatus to:
obtain locations of n original track points P₁ to Pₙ during a moving process of a mobile terminal, wherein a time point at which the mobile terminal passes an i^{th} original track point Pᵢ in the n original track points P₁ to Pₙ is earlier than a time point at which the mobile terminal passes an (i+1)^{th} original track point Pᵢ₊₁, and n and i are positive integers;
perform a filtering filtering process on the n original track points P₁ to Pₙ, wherein the filtering process one or more of:
deletes at least one of the n original track points P₁ to Pₙ, or
updates a location of at least one of then original track points P₁ to Pₙ; and
determine a moving track of the mobile terminal on at least one road included in a road map comprising a plurality of roads based on target track points obtained by performing the filtering process on the n original track points P₁ to Pₙ.

18. The non-transitory computer-readable medium according to claim 17, wherein the apparatus is further caused to:
obtain a to-be-filtered points Pₓ to Pₓ₊ₐ₋₁ in the n original track points P₁ to Pₙ, wherein the a to-be-filtered points Pₓ to Pₓ₊ₐ₋₁ are located at a first location, and x and a are positive integers;
obtain b to-be-filtered points Pₓ₊ₐ to P_{x+a+b-1} in the n original track points P₁ to Pₙ, wherein the b to-be-filtered points Pₓ₊ₐ to P_{x+a+b-1} are located at a second location, and b is a positive integer greater than 1;
obtain c to-be-filtered points P_{x+a+b} to P_{x+a+b+c-1} in the n original track points P₁ to Pₙ, wherein the c to-be-filtered points P_{x+a+b} to P_{x+a+b+c-1} are located at a third location, c is a positive integer, and x+a+b+c−1 is less than or equal to n;
evenly arrange to-be-filtered points P_{x-└a/2┘} to P_{x+a-└b/2┘} on a straight line from the first location to the second location; and
evenly arrange to-be-filtered points P_{x+a+└b/2┘} to P_{x+a+b+└c/2┘} on a straight line from the second location to the third location, wherein └ ┘ indicates rounding down.

19. The non-transitory computer-readable medium according to claim 17, wherein the apparatus is further caused to:
obtain a speed at a first to-be-filtered point Pₐ in the n original track points P₁ to Pₙ, wherein a is a positive integer less than or equal to n; and
delete the first to-be-filtered point Pₐ based on a determination that the speed at the first to-be-filtered point Pₐ is greater than or equal to a preset speed.

20. The non-transitory computer-readable medium according to claim 19, wherein the apparatus is further caused to:
obtain the first to-be-filtered point Pₐ and a second to-be-filtered point P_{b} in the n original track points P₁ to Pₙ, wherein b=a+1 or b=a−1, and a is less than n; and
determine that an average speed in a distance from the first to-be-filtered point Pₐ to the second to-be-filtered point P_{b} is the speed at the first to-be-filtered point Pₐ.
